(19) United States
(12) Patent Application Publication
(10) Pub. No.: US 2019/0375688 A1
(43) Pub. Date: Dec. 12, 2019

(54) SINTERING CONTROL METHOD OF CERAMIC MANUFACTURING

(71) Applicant: RegenBone Biomedical Inc., Taipei (TW)

(72) Inventors: Tzong-Li LIN, Taipei (TW); Chih-Yang LIN, TAIPEI (TW); Lung-Yi CHEN, TAIPEI (TW); Chia-Jie CHEN, TAIPEI (TW)

(21) Appl. No.: 16/436,677

(22) Filed: Jun. 10, 2019

(30) Foreign Application Priority Data
Jun. 12, 2018 (TW) 107120174

(51) Int. Cl. C04B 38/06; B28B 1/00; B28B 11/24; B33Y 10/00; B33Y 70/00

(52) U.S. Cl. CPC C04B 38/068; B28B 1/001; B28B 11/243; C04B 2235/6583; B33Y 70/00; C04B 2235/6026; C04B 2235/661; B33Y 10/00

(57) ABSTRACT

The present invention provides a sintering control method of ceramic manufacturing. The method includes the following steps: S1: preparing a pore-forming agent containing a porogen; S2: mixing the pore-forming agent with a ceramic slurry and forming a greenpart; S3: sintering the greenpart at a first temperature in an oxygen-free environment to form a semi-finished object; and S4: sintering the semi-finished object at a second temperature in an oxygen-containing environment to form a ceramic article. Wherein, the first temperature is higher than the second temperature. While the porogen is a carbon-based material, the second temperature is from 300° C. to 600° C., and the porosity of the ceramic article may reach 30% to 70%. By this method, the property of the ceramic article (including mechanical strength, porosity, pore shape and size) can be designed according to requirement and controlled for quality assurance.

### CROSS-REFERENCE TO RELATED APPLICATIONS

This application claims the priority benefit of Taiwan Application No. 107120174, filed on Jun. 12, 2018, the disclosure of which is incorporated herein by reference.

### BACKGROUND OF THE INVENTION

### 1. Field of the Invention

The present invention provides to a sintering control method of ceramic manufacturing, more particularly, to a method of multi-stage sintering to control porosities and pore sizes of the ceramic material.

### 2. Description of the Prior Art

Ceramic engineering is a kind of science and technology by using inorganic non-metallic materials to manufacture objects. Ceramic materials are widely applied on materials engineering, electrical engineering, chemical engineering, and mechanical engineering. Since the ceramic has good thermal stability, it can be used in the applications while metals and polymers are not suitable, such as mining, aerospace, biomedicine, refining, food and chemical plants, electronics, industrial power transmission, optical waveguide transmission, and so on.

According to different requirements from various application areas, the properties of ceramic materials need to be specified and optimized. In the biomedical field, it is necessary to evaluate the porosity of the implant when developing an alternative implant for human bone. The porosity has significant effects on the physical properties and the biological interactions between the implant and the surrounding tissue. The increase of porosity enlarges the surface area for building tissue-implant interaction, enhancing the mechanical integration and increasing the resorption rate of the implant. In the case of segmental bone defects, a natural bone porous structure (porous central portion surrounded by dense outer shell) simulated implant will be ideal for bone defect substitution, while combining both critical properties (permeability of bone marrow and physical support) of natural bone.

However, the property of pores in ceramics is difficult to control accurately since the ceramic molecular rearranges unpredictably in the sintering process, and lead to the instability of product quality. For the sake of accurately adjusting the porosity, low temperature sintering process is widely used in the industry, but lead to the decrease of mechanical strength of ceramic materials. Therefore, there is a need in the industry for a new ceramic sintering technology that can accurately control porosities and pore sizes while producing ceramics with high strength and high consistency under sufficient high temperatures.

### SUMMARY OF THE INVENTION

Therefore, the present invention provides a sintering control method of ceramic manufacturing to achieve a new ceramic material property by two-stage sintering. In the first stage, the greenpart is formed to be a semi-finished object with high abrasion resistance. In the second stage, the pore-forming agent in the semi-finished object is burned off, and the remaining void is the pore in control.

The sintering control method of ceramic manufacturing of the present invention includes the following steps: S1: preparing a pore-forming agent containing a porogen; S2: mixing the pore-forming agent with a ceramic slurry and forming a greenpart; S3: sintering the greenpart at a first temperature in an oxygen-free environment to form a semi-finished object; S4: sintering the semi-finished object at a second temperature in an oxygen-containing environment to form a ceramic article. Wherein, the second temperature is lower than the first temperature.

In the step S1, the porogen is a carbon-based material, an ore, a salt, a natural fiber or a high molecular polymer, and the carbon-based material further is a carbon fiber, a carbon nanotube, a graphene or an expanded graphite. Wherein the shape of the carbon-based material is spherical, plate, irregular, strip or cube.

In the step S1, the particle size of the porogen is from 50 nm to 400 82 m. In one better embodiment, the particle size of the porogen is from 50 nm to 100 μm.

In one embodiment, the Step S2 further includes the following sub steps: S21: mixing the pore-forming agent with a ceramic slurry according to a predetermined ratio for forming a mixed raw material; and S22: printing the mixed raw material by additive manufacturing for forming the greenpart.

In the step S21, the pore-forming agent accounts for the predetermined ratio of the mixed raw material from 0 wt % to 50 wt %. In one better embodiment, the pore-forming agent accounts for the predetermined ratio of the mixed raw material from 0 wt % to 35 wt %.

In one embodiment, the step S3 further includes the following sub steps : S31: injecting a stabilizing gas into a predetermined environment for establishing the oxygen-free environment; and S32: sintering the greenpart at the first temperature in the oxygen-free environment for forming the semi-finished object.

In the step S31, the stabilizing gas is nitrogen gas. In the step S32, the first temperature is higher than 600° C. In one better embodiment, the first temperature is from 1200° C. to 1800° C.

In one embodiment, the step S4 further includes the following steps: S41: injecting air into a predetermined environment for establishing the oxygen-containing environment; and S42: sintering the semi-finished object from 1 to 10 hours at the second temperature in the oxygen-containing environment for forming the ceramic article, wherein the second temperature is between 300° C. and 600° C.

In the step S4, the porosity of the ceramic article in the step S4 is from 30% to 70%. In one better embodiment, the porosity of the ceramic article in the step S4 is from 30% to 60%.

In summary, the sintering control method of ceramic manufacturing of the present invention contain both using a pore-forming agent and two-stage sintering process which under oxygen-free and oxygen environment respectively to control the corresponding sintering temperature of the ceramic material. Therefore, the obtained ceramic articles have the consistency and mechanical strength after high-temperature sintering, and can avoid the porosity lost in high-temperature sintering process. Especially, the method of the present invention indicates a precise control of the porosity and the pore shape in the ceramic articles by adjusting the ratio, shape and size of the porogen. Therefore, the present invention offers a precise ceramic manufacturing process for unlimited application in various field.

### BRIEF DESCRIPTION OF THE APPENDED DRAWINGS

FIG. 1 shows a flow diagram of a sintering control method of ceramic manufacturing in an embodiment of the present invention.

FIG. 2 shows a flow diagram of the sintering control method of ceramic manufacturing in another one embodiment of the present invention.

FIG. 3 shows a flow diagram of the sintering control method of ceramic manufacturing in another one embodiment of the present invention.

FIG. 4 shows a flow diagram of the sintering control method of ceramic manufacturing in another one embodiment of the present invention.

FIG. 5 shows the effect of the ratio of carbon-based materials on porosity in an embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments.

In the description of the present invention, it is to be understood that the orientations or positional relationships of the terms “longitudinal, lateral, upper, lower, front, rear, left, right, top, bottom, inner, outer” and the like are based on the orientation or positional relationship shown in the drawings is merely for the convenience of the description of the present invention and the description of the present invention, and is not intended to indicate or imply that the device or component referred to has a specific orientation, is constructed and operated in a specific orientation, and therefore cannot be understood as Limitations of the invention.

Furthermore, the indefinite article “a”, “an” and “the” preceding the device or element of the present invention is not limited to the number of devices or components required (i.e., the number of occurrences). Therefore, “a”, “an” and “the” should be interpreted as including one or at least one, and singular forms of devices or elements also include plural forms, unless the stated quantity is explicitly referred to as the singular form.

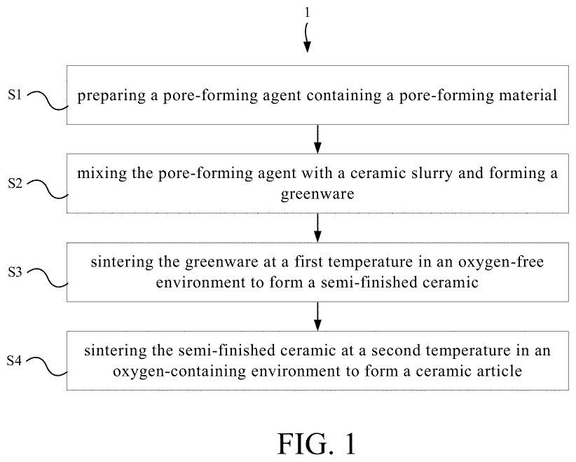

Please refer to FIG. 1. FIG. 1 shows a flow diagram of a sintering control method of ceramic manufacturing 1 in an embodiment of the present invention. The sintering control method of ceramic manufacturing 1 includes the following steps: S1: preparing a pore-forming agent containing a porogen; S2: mixing the pore-forming agent with a ceramic slurry and forming a greenpart; S3: sintering the greenpart at a first temperature in an oxygen-free environment to form a semi-finished object; and S4: sintering the semi-finished object at a second temperature in an oxygen-containing environment to form a ceramic article. Wherein, the second temperature is lower than the first temperature.

In the step S1, the porogen is a carbon-based material, an ore, a salt, a natural fiber or a high molecular polymer, and the carbon-based material can be selected from a carbon fiber, a carbon nanotube, a graphene or an expanded graphite. Furthermore, the carbon-based material can be mixed with natural organic fine powder, pulverized coal, limestone, dolomite, burnt zeolite, perlite, pumice, or the like, or the remaining porogen commonly used in the industry to form the pore-forming agent.

In the step S1, the shape of the carbon-based material is spherical, plate, irregular, strip or cube. Wherein, the particle size of the carbon-based material is from 50 nm to 400 μm. In one better embodiment, the particle size of the carbon-based material is from 50 nm to 100 μm. For example, in one embodiment, the carbon-based material is a flat plate graphene or a flat film graphene with 100 nm of thickness and 100 μm of length and width. In another one embodiment, the carbon-based material is a long tube type carbon nanotube with 50 nm of diameter and 10 μm of length. However, the type, shape, and size of the carbon-based material are not limited thereto, and the types, shapes, and sizes of that can be reasonably replaced according to the prior art by those skilled in the art are all within the scope of the invention, and are not detailed in the specification.

In one embodiment, the ceramic material can be a non-metallic inorganic material such as a silicate material, an aluminosilicate material, a fine ceramic material, a diatomite, a corundum and carborundum material, a cordierite or an aluminum titanate material. The ceramic material also includes traditional ceramic material and new ceramic material. The new ceramic material further includes aluminum oxide, zirconium oxide, magnesium oxide, chromium oxide, titanium dioxide, tungsten carbide, titanium carbide, chromium carbide, silicon carbide, boron carbide, titanium nitride, silicon nitride or boron nitride. Moreover, the ceramic material can be a powder or a slurry.

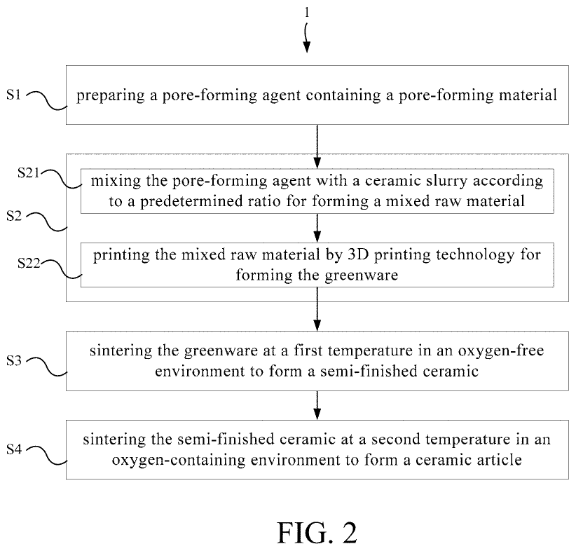

Please refer to FIG. 2. FIG. 2 shows a flow diagram of the sintering control method of ceramic manufacturing 1 in another one embodiment of the present invention. In one embodiment, the step S2 of mixing the pore-forming agent with a ceramic slurry and forming a greenpart further includes the following sub steps: S21: mixing the pore-forming agent with a ceramic slurry according to a predetermined ratio for forming a mixed raw material; and S22: printing the mixed raw material by additive manufacturing for forming the greenpart. Wherein, the additive manufacturing can be nozzle extrusion, stereolithography (surface exposure and laser), photocuring, adhesive injection, selective laser sintering or melt molding or slurry-layer casting.

In one embodiment, the pore-forming agent can be mixed with the ceramic slurry to form the mixed raw material according to the predetermined ratio, and then the mixed raw material is sent out from the nozzle of the additive manufacturing device to form a greenpart with evenly distribution of the pore-forming agent. Alternatively, the pore-forming agent and the ceramic material are not mixed first, but are respectively sent out by the nozzle to form a laminated greenpart. Alternatively, the pore-forming agent and the ceramic material are separated at first, but in a mixing chamber of the additive manufacturing machine. The ratio of the pore-forming agent and the ceramic material is adjusted by the additive manufacturing machine according to the parameter setting, and then sent out by the nozzle to form a plurality of greenpart having different ratios of pore-forming agents. In the step S21, the pore-forming agent accounts for the predetermined ratio of the mixed raw material from 0 wt % to 50 wt %. In a better embodiment, the pore-forming agent accounts for the predetermined ratio of the mixed raw material from 0 wt % to 35 wt %. For example, the ratio of pore-forming agent of one zone of the greenpart is 0 wt %, and the ratio of pore-forming agent of the other zone of the greenpart is 35 wt %.

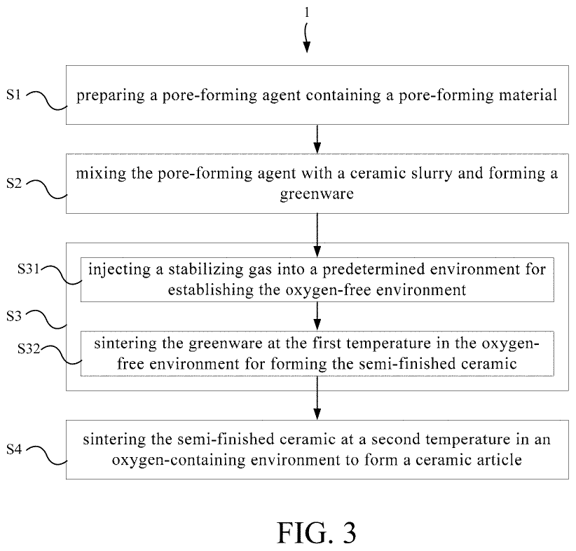

Please refer to FIG. 3. FIG. 3 shows a flow diagram of the sintering control method of ceramic manufacturing 1 in another one embodiment of the present invention. In one embodiment, the step S3 of sintering the greenpart at a first temperature in an oxygen-free environment to form a semi-finished object further includes the following sub steps: S31: injecting a stabilizing gas into a predetermined environment for establishing the oxygen-free environment; and S32: sintering the greenpart at the first temperature in the oxygen-free environment for forming the semi-finished object.

In the prior art, the forming of the ceramic requires only one sintering and does not limit the sintering environment. In the present invention, the greenpart is sintered to form a semi-finished object in an oxygen-free environment. During sintering process, the microstructure of the ceramic molecular rearrange the crystallization due to high-temperature effect, making the material denser and enhancing the strength and hardness of the material. After oxygen-free sintering process, the sintering mechanism accomplished while the porogen remained in the greenpart.

In the step S31, the stabilizing gas is a non-oxygen gas which is stable such as nitrogen, helium, neon, argon, krypton, xenon, and so on. In the step S32, the first temperature is higher than 600° C. In one embodiment, the first temperature is from 1200° C. to 1800° C., and the first temperature is a suitable range for sintering most of the ceramic material. However, the temperature is not limited to the mentioned numbers, the range of the first temperature should be considered according to the stability of porogen and the melting point of the ceramic material. When a carbon-based material is used, it is an ideal choice of the first temperature between 1200° C. and 1800° C., while carbon remains stable in this environment.

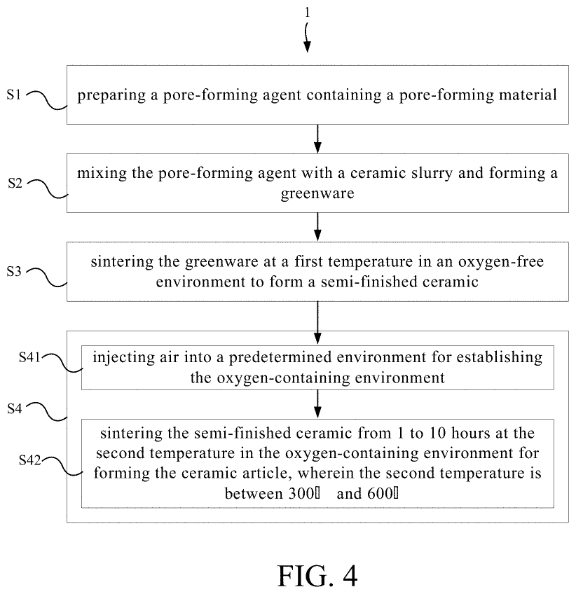

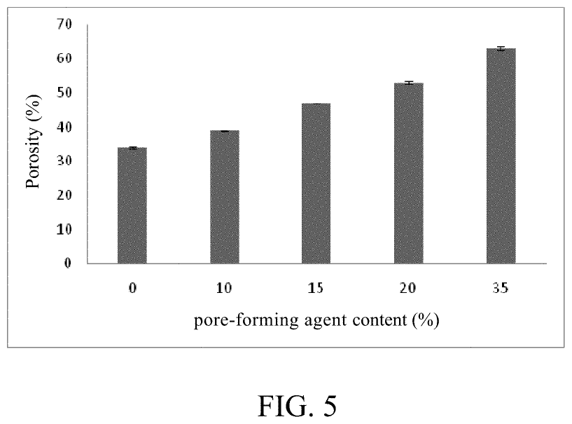

Please refer to FIG. 4 and FIG. 5. FIG. 4 shows a flow diagram of the sintering control method of ceramic manufacturing 1 in another one embodiment of the present invention. FIG. 5 shows the effect of the ratio of carbon-based materials on porosity in an embodiment of the present invention. In one embodiment, the step S4 further includes the following sub steps: S41: injecting air into a predetermined environment for establishing the oxygen-containing environment; and S42: sintering the semi-finished object from 1 to 10 hours at the second temperature in the oxygen-containing environment for forming the ceramic article.

The predetermined environment mentioned in step S3 and step S4 can be a sintering furnace, and step S3 and step S4 use the same sintering furnace. The non-oxygen gas is injected into the sintering furnace to form an oxygen-free environment in the step S3. The air is injected into the furnace to form an oxygen-containing environment in the step S4. In the step S4, in addition to the air, the oxygen or any gas containing oxygen can also be injected into the sintering furnace

In this stage, the purpose of the second sintering is to oxidize the porogen to a gaseous state at a high temperature, such as the carbon-based material is oxidized to the carbon monoxide or carbon dioxide. The oxidized gas of the porogen releases from the remaining fine pores, so that the position occupied by the porogen will leave new pores. The second temperature is lower than the first temperature. When the second temperature is from 300° C. to 600° C., the second temperature is a suitable range for burning off the porogen and keeping the structure of ceramic object. Therefore, the shape and size of the pores maintain the shape and size of the poogen, and the purpose of controlling the porosity and pore shape of the ceramic object is achieved. The sintering time of this stage is not limited to 1 to 10 hours, it should be considered according to the property of ceramic material and prorogen which is used.

The key point of the present invention is the high temperature and oxygen-free sintering in the stage 1, and low temperature and oxygen-containing sintering in the stage 2. The purpose of the high temperature sintering is to make and form the ceramic, dense and high mechanical strength, and the purpose of the oxygen-free is to avoid gasification of porogen. The stage 2 is to use the oxygen to gasify the porogen to form pores with required size, shape and number, and keep the low temperature to avoid the formed pores being eliminated. Therefore, the first temperature is suitable for sintering the ceramic material to tighten and maintain the shape of the porogen, and the second temperature is suitable for gasifying the porogen and avoiding the large shrinkage of the ceramic article. The specific temperature values in this specification are only the parameters in one embodiment and should not be limited in the present invention.

When the pore-forming agent accounts for the predetermined ratio of the mixed raw material from 10 wt % to 50 wt %, the porosity of the ceramic article is from 30% to 70%. As shown in FIG. 5, the experimental conditions are that the porogen contains a carbon-based material, the first temperature is from 1200° C. to 1800° C., and the second temperature is from 300° C. to 600° C. The porosity of the ceramic article is measured after processing the sintering method of the present invention according to the different ratio with the pore-forming agent and the ceramic material. When the pore-forming agent accounts for the predetermined ratio of the mixed raw material from 0 wt % to 35 wt %, the porosity of the ceramic article sintered in the step S4 is from 30% to 60%. It can be seen from the experimental diagram that the standard error of forming the porosity is small, and the adjustment of the predetermined ratio of the pore-forming agent can stably control the change of the porosity. Compared with the prior art, the porosity of each sintered ceramic material is difficult to control, so that the degree of compactness and mechanical strength of the sintered ceramic material will be affected. The method of the present invention can precisely control the porosity and produce the ceramic article of uniform quality.

In addition, the sintering control method of ceramic manufacturing also can applied to the sol-gel method; at this time, the high temperature in the step S3 is not limited to over 600° C., and the temperature also can be lower than 600° C.

Compared with the conventional technique, the sintering control method of ceramic manufacturing of the present invention contain both using a pore-forming agent and two-stage sintering process which under oxygen-free and oxygen environment respectively to control the corresponding sintering temperature of the ceramic material. Therefore, the obtained ceramic article can keep the consistency and mechanical strength after high-temperature sintering process while the porous structure can be controlled by adjusting the ratio, shape and size of the porogen. Therefore, the present invention offers a precise ceramic manufacturing process for unlimited application in various field.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A sintering control method of ceramic manufacturing, comprising the following steps:
S₁: preparing a pore-forming agent containing a porogen;
S₂: mixing the pore-forming agent with a ceramic slurry and forming a greenpart;
S₃: sintering the greenpart at a first temperature in an oxygen-free environment to form a semi-finished object; and
S₄: sintering the semi-finished object at a second temperature in an oxygen-containing environment to form a ceramic article.
wherein, the second temperature is lower than the first temperature.

2. The method of claim 1, wherein the porogen in the step S1 is a carbon-based material, an ore, a salt, a natural fiber or a high molecular polymer, and the carbon-based material is a carbon fiber, a carbon nanotube, a graphene or an expanded graphite.

3. The method of claim 2, wherein the shape of the carbon-based material in the step S1 is spherical, plate, irregular, strip or cube.

4. The method of claim 1, wherein the particle size of the porogen in the step S1 is from 50 nm to 400 μm.

5. The method of claim 1, wherein the step S2 further comprises the following steps:
S21: mixing the pore-forming agent with a ceramic slurry according to a predetermined ratio for forming a mixed raw material; and
S22: printing the mixed raw material by additive manufacturing for forming the greenpart.

6. The method of claim 5, wherein the pore-forming agent in the step S21 accounts for the predetermined ratio of the mixed raw material from 10 wt % to 50 wt %.

7. The method of claim 1, wherein the step S3 further comprises the following steps:
S31: injecting a stabilizing gas into a predetermined environment for establishing the oxygen-free environment; and
S32: sintering the greenpart at the first temperature in the oxygen-free environment for forming the semi-finished object.

8. The method of claim 7, wherein the stabilizing gas in the step S31 is nitrogen gas, and the first temperature in the step S32 is higher than 600° C.

9. The method of claim 1, wherein the step S4 further comprises the following steps:
S41: injecting air into a predetermined environment for establishing the oxygen-containing environment; and
S42: sintering the semi-finished object from 1 to 10 hours at the second temperature in the oxygen-containing environment for forming the ceramic article, wherein the second temperature is between 300° C. and 600° C.

10. The method of claim 1, wherein the porosity of the ceramic article in the step S4 is from 30% to 70%.
